(19) United States
(12) Patent Application Publication
(10) Pub. No.: US 2012/0200090 A1
(43) Pub. Date: Aug. 9, 2012

(54) Energy source system and method

(76) Inventor: Ezra Shimshi, Atlanta, GA (US)

(21) Appl. No.: 12/931,658

(22) Filed: Feb. 7, 2011

(51) Int. Cl. H02K 7/18; H02N 11/00

(52) U.S. Cl. 290/1 A; 74/DIG. 9

(57) ABSTRACT

An energy source system could include sets of two units of one rotating magnet and two swinging targets in each unit on a single spindle. In each unit one swinging target could swing over the spindle in one direction and the other swinging target would swing under the spindle in the opposite direction. The rotating magnet in each unit could ascend and descend driving the over the spindle swinging target, positioned at the inner side of the rotating magnet, from the 90 degrees mark to the 270 degrees mark over the spindle and would descend and ascend driving the under the spindle swinging target, positioned at the outer side of the rotating magnet, from the 270 degrees mark to the 90 degrees mark under the spindle. The rotating magnet in each unit could shuttle inward toward the over the spindle swinging target at the 90 degrees mark and outward toward the under the spindle target at the 270 degrees mark on a one-way linear direction. The rotating magnet, which drives the spindle and a flywheel and also drives the swinging targets, could rotate in a steady speed rate of rotation due to the inertia of the flywheel.

### BACKGROUND OF THE INVENTION

a) Field of the Invention

The present invention relates to energy source systems, each system comprising of rotating magnets and swinging targets configured to convert one-way linear energy into rotary energy as the rotating magnets shuttle between their respective swinging targets in said one-way linear direction.

b) The Prior Art

In the past and at the present the only energy sources for everyday applications have been external energy sources which are unreliable because of their dependency on external conditions.

### SUMMARY OF THE INVENTION

An embodiment of the present invention could include one spindle, one flywheel, one target that swings over the spindle, one target that swings under the spindle and one rotating magnet that drives the spindle, the flywheel and the swinging targets by shuttling between the swinging targets.

One of the objects of the invention is to provide an apparatus with energy form within it that could be converted to other energy forms and is independent of external conditions.

Another one of the objects of the invention is to provide energy source systems and methods for various tasks and applications, anywhere, whether on a planet or in space.

### BRIEF DESCRIPTION OF THE DRAWINGS

The present invention will be more readily understood by reference to the following description, taken with the accompanying drawings, in which:

FIG. 1 is a perspective view showing one version of embodiment of the invention. FIG. 1 shows a spindle held by a frame, a flywheel, a magnet with its mass and its counterbalance weight and two targets with their respective pendulum weights. The magnet and its mass are seen as being blocked by an inner blocker to keep the magnet at a predetermined minimum distance from the over the spindle swinging target which is seen after having trapped the magnet with its trapdoor and trigger. The magnet is seen after having rotated and reached its highest point while driving the over the spindle swinging target and both are seen about to descend to the back. Also seen are the over the spindle swinging springy hammer, the under the spindle swinging springy anvil and the under the spindle swinging target.

FIG. 2 is the perspective view showing the same embodiment as shown in FIG. 1, but after the rotating magnet descended to the back and driving the over the spindle swinging target and after the rotating magnet has been trapped by the ascending under the spindle swinging target with its trapdoor and trigger and the swinging targets change their swings direction and after the rotating magnet shuttled toward the under the spindle swinging target which is seen blocked by the outer blocker to keep the rotating magnet at the predetermined minimum distance from the under the spindle swinging target. The rotating magnet and the under the spindle swinging target are seen about to assent to the front from their lowest point.

FIG. 3 shows an embodiment of the invention that combines the two embodiments in the two positions of the rotating magnets as shown in FIG. 1 and in FIG. 2 on a single spindle. The flywheel is seen fixed to the spindle between said two embodiments. The counterbalance weight to each of the rotating magnet has been eliminated because the two rotating magnets are positioned opposite to each other and so balance each other.

### DESCRIPTION OF THE PRESENT EMBODIMENT

Parts of the embodiment and their designated numbers in the drawings are:

5—Frame; 6—Anvil; 7—Flywheel; 8—Magnet; 9—Hammer; 10—Spindle; 11—Pendulum weight with the anvil; 12—Target swinging over the spindle; 13—Target swinging under the spindle; 14—Trapdoor for target 12; 15—Trapdoor for target 13; 16—Trigger for trapdoor 14; 17—Trigger for trapdoor 15; 18—Counterbalance weight; 19—Blockers; 20—Pendulum weight with the hammer.

The invention may be implemented in a wide range of embodiments.

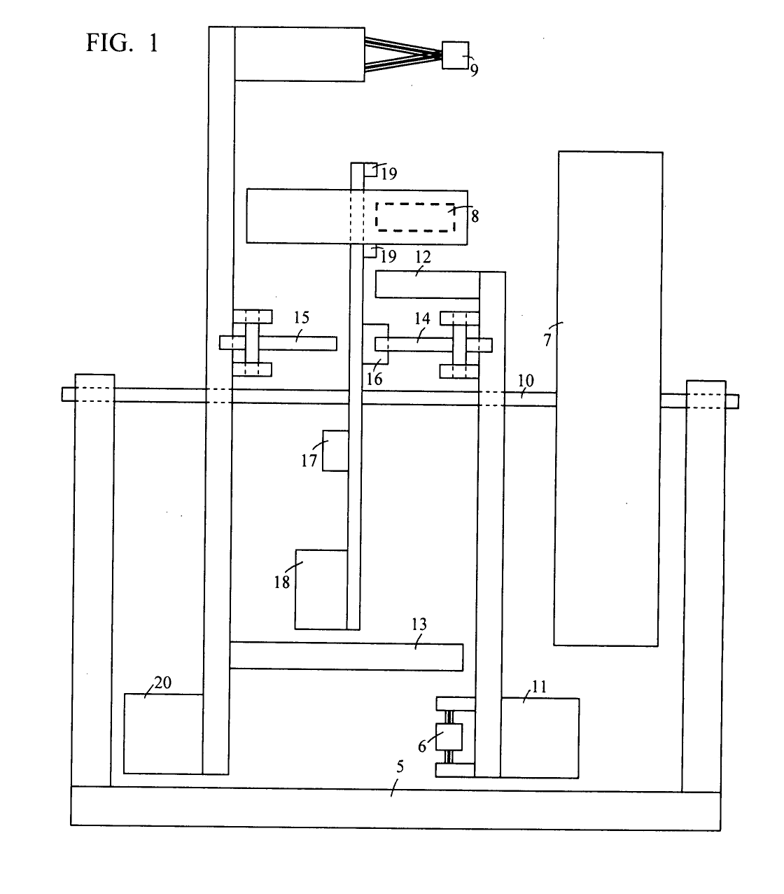

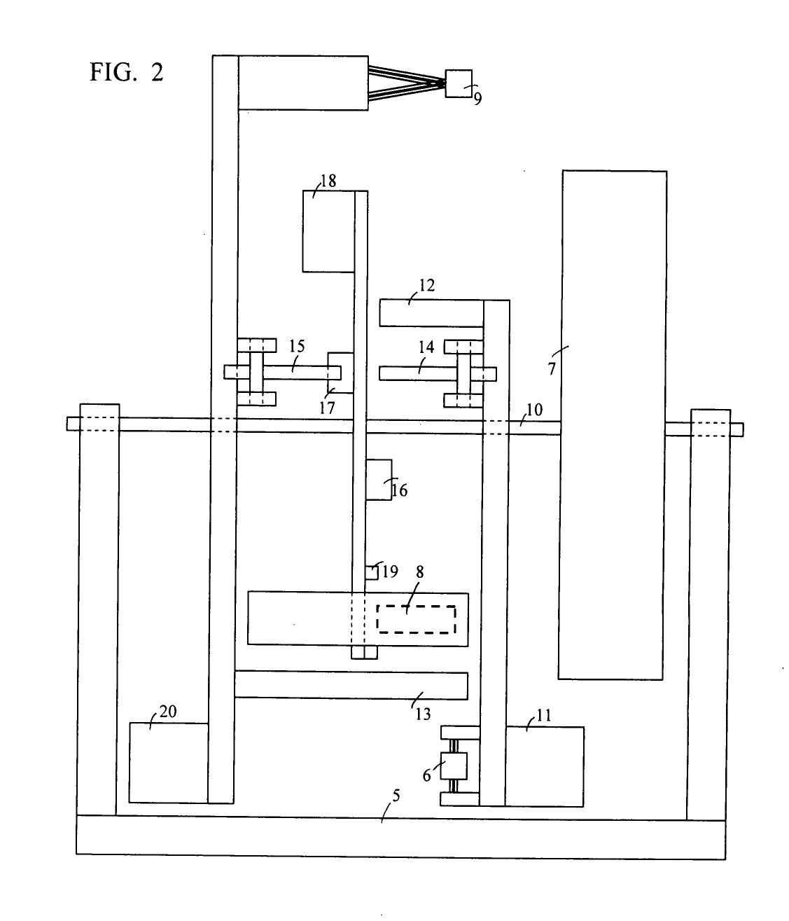

Referring to FIG. 1, thereof, the embodiment includes the rotating magnet 8 with its mass on one end of an arm and counterbalance weight 18 on the other end of said arm, which is fixed to the spindle 10. The spindle 10 is held by the frame 5 and the flywheel 7 is fixed to the spindle 10. The rotating magnet 8 and its mass are being blocked by the inner blocker 19 after the rotating magnet 8 shuttled with its mass inward toward spindle 10 along said arm. The over the spindle swinging target 12 had trapped the rotating magnet 8 with the trapdoor 14 and trigger 16 and was driven by the rotating magnet 8 to the highest point in the rotation path of the rotating magnet 8. The rotating magnet 8 is about to rotate to the back with the over the spindle swinging target 12. The under the spindle swinging target 13 is seen about to continue its swing to the back while its corresponding over the spindle swinging springy hammer 9 is about to continue its swing to the front. As soon as the rotating magnet 8 and the over the spindle swinging target 12 encounter the under the spindle swinging target 13 at 270 degrees mark, or at the western zone, in the back, the rotating magnet 8 would be positioned between the two swinging targets. At that instant the over the spindle swinging springy hammer 9 of pendulum weight 20 would pound on the under the spindle swinging springy anvil 6 of pendulum weight 11 at the 90 degrees mark, or at the eastern zone, in the front. Said pounding would bring about swifter change in the swings direction of the swinging targets, which effectively would prevent the swinging targets from pausing during their swings change and would equalize the forces impacted on the pendulum weights so that they could maintain their swing heights. The over the spindle swinging target 12 would at that instant departs from the rotating magnet 8 and would swing upward after the under the spindle swinging target 13 had trapped the rotating magnet 8 with the trapdoor 15 and the trigger 17 until the rotating magnet 8 had shuttled with its mass toward the under the spindle swinging target 13 and blocked by blocker 19 and both continue downward to their lowest point as is shown in FIG. 2. At the 90 degrees mark, or at the eastern zone, in the front, the rotating magnet 8 and the under the spindle swinging target 13 encountered the over the spindle swinging target 12, and again the rotating magnet 8 is positioned between the two swinging targets. At that exact instant, the over the spindle swinging springy hammer 9 pounds on the under the spindle swinging springy anvil 6, but this time at the 270 degrees mark, or at the western zone, in the back. The over the spindle swinging target 12, at said instance, traps the rotating magnet 8 with the trapdoor 14 and the trigger 16 until the rotating magnet 8 shuttled with its mass toward the over the spindle swinging target 12 and is blocked by blocker 19. The rotating magnet 8 continues its steady rotation driving the over the spindle swinging target 12 upward to their highest point as shown in FIG. 1 and downward to the back to encounter the ascending under the spindle swinging target 13. In FIG. 1 the balance is seen tipped from the rotating magnet 8 toward its counterbalance weight 18 and together with conserving its angular momentum by shuttling with its mass toward its axis of rotation the rotating magnet 8 accelerates to offset deceleration.

FIG. 2 shows the rotating magnet 8 after having been trapped by the under the spindle swinging target 13 with the trapdoor 15 and the trigger 17. The rotating magnet 8 and the under the spindle swinging target 13 are seen about to ascend to the front from their lowest point. The rotating magnet 8 is seen being blocked by the outer blocker 19 when the rotating magnet 8 shuttled with its mass outward toward the under the spindle swinging target 13. In FIG. 2 the balance had been tipped away from the counterbalance weight 18 toward the descending magnet 8 in the back, which would have produced more acceleration in the rotation of magnet 8 that offsets deceleration of said rotation.

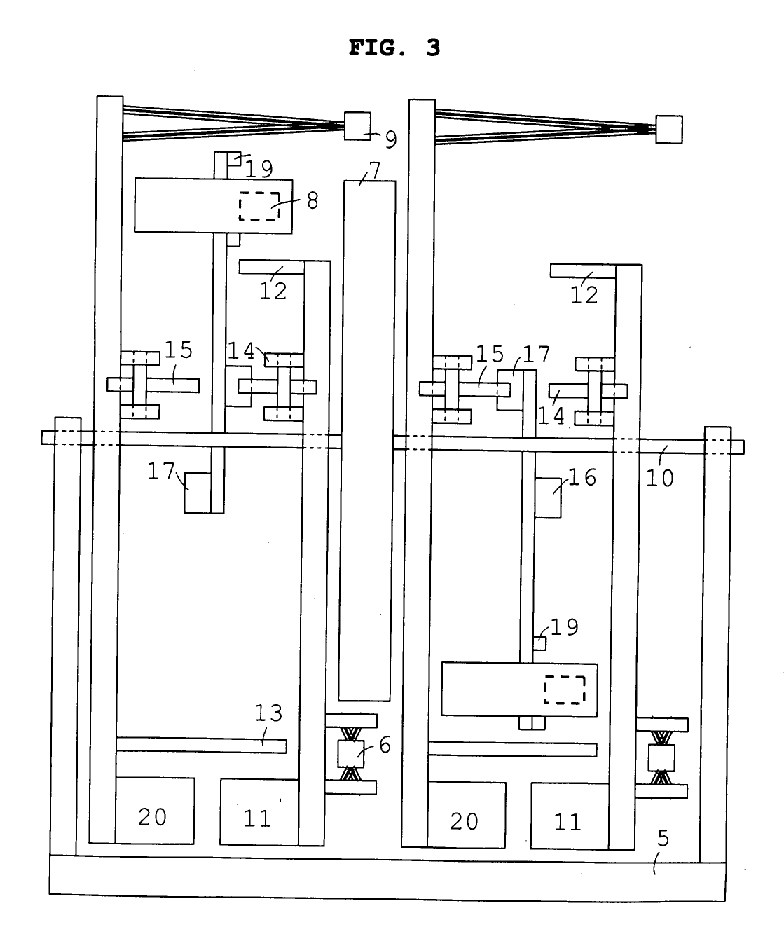

FIG. 3 shows the combination of the two system units as shown in FIG. 1 and FIG. 2. The rotating magnets 8 are seen opposite to each other on the single spindle 10. Since the rotating magnets 8 are positioned opposite to each other the counterbalance weights 18 are eliminated. The combination in such a set of two units, or even with another set at 90 degrees angle to the first set, made it possible to build a system with greater and greater capacity even with smaller and less powerful magnets. In such higher capacity system the flywheel 7, the over the spindle swinging springy hammer 9 and the under the spindle swinging springy anvil 6 are configured to make sure the motions of the magnets and the targets are kept steady, even with the unutilized potential energy in the system. This available and unused potential energy could be stored in another high speed flywheel connected to the system through various means, such as ratchet gear and other gears, for example, or be extracted as output energy directly to a specific application.

In FIG. 3, when one rotating magnet 8 is at the front the other rotating magnet 8 is at the back and both rotating magnets shuttle in one-way linear direction at the same time so that the balance is always tipped toward the back rotating magnet 8 that descends. Since each rotating magnet 8 falls downward with target 13 and with pendulum weight 20 after shortening the arm of the rotating magnet 8 opposite to pendulum weight 20, it energizes pendulum weight 20 to reach its original swinging height and potentially even higher. The hammering by the over the spindle swinging springy Hammers 9 on the under the spindle swinging springy anvils 6 spreads its impact equally among the swinging pendulum weights and they maintain their steady swings and the heights of their swings.

At the 90 degrees zone in the front and at the 270 degrees zone in the back each rotating magnet 8 would be positioned between their respective two swinging targets, but without making contact due to the blockers 19. These gaps between each rotating magnet 8 and its respective swinging targets and together with the inertia of flywheel 7 and the hammering by the over the spindle swinging springy hammers 9 upon the under the spindle swinging springy anvils 6 are configured to bring about swifter swings direction change by the swinging targets and steady rotation by the rotating magnets 8 as said rotating magnets shuttle in a linear one-way direction.

An embodiment of the present invention could include one rotating magnet and two swinging magnets, or two swinging magnets and one rotating mass-unit that could be shuttled by the magnetic field of each of the swinging magnets.

The trapdoors could return to their trapping positions by the pull of gravity alone or by additional or other means after being opened by their respective triggers.

An embodiment of the present invention, as an example, that includes one rotating magnet and two swinging targets as shown in FIG. 2 could be made to run, for example, by hanging each pendulum weight on a string. The strings should be tied loosely to the pendulum weights so that they would release the pendulum weights when under a predetermined strain. By simply lifting pendulum weight 11 by its string to the 270 degrees mark and lifting pendulum weight 20 by its string to the 90 degrees mark, at the same time, with a force that is a little more than the force of said swinging pendulum when they swing on their own, the rotating magnet, which is with pendulum 20, should be between the two swinging targets at the 90 degrees mark, the hammer should be pounding on the anvil at the 270 degrees mark, the rotating magnet should be trapped by the swinging target 12 and the system should continue to run on its own as soon as the rotating magnet had shuttled towards its axis of rotation.

The applications for the present invention are vast. Its embodiments and methods could be used inside electric vehicles to charge their batteries and could even be deployed in space travels inside revolving chambers to provide the necessary artificial pull that resembles the pull of gravity.

While the present invention has been described with reference to the mechanism disclosed herein, it is not confined to the details as set forth and is not intended in any way to limit the broad features or principles of the present invention, or the scope of patent monopoly to be granted. The applications are intended to cover any modification or changes that may come within the scope of the following claims.

What is claimed is:

1. Energy source system, comprising a single spindle on a frame and one or more sets of magnets and targets, wherein each set comprising two units riding the spindle opposite to each other, which include one rotating magnet and two swinging targets that swing by their respective pendulum weights in each unit, wherein the rotating magnets are configured to turn the spindle in one direction and means for the rotating magnets to shuttle between their respective swinging targets in one-way linear direction.

2. The energy source system according to claim 1, wherein the swinging targets in each unit are configured to swing in the opposite direction to each other, one swinging target over the spindle and the other swinging target under the spindle and to encounter the rotating magnet so that the rotating magnet is between the two swinging targets at the 90 degrees zone and at the 270 degrees zone, wherein the over the spindle swinging target encounters the rotating magnet on the inner side of the rotating magnet and the under the spindle swinging target encounters the rotating magnet on the outer side of the rotating magnet.

3. The energy source system according to claim 1, wherein the means for the rotating magnets to shuttle between their respective swinging targets in one-way linear direction include a flywheel fixed to the spindle and is configured to store rotary energy and to feedback the system with said energy, wherein said means for the rotating magnets to shuttle also include blockers adapted to block their respective rotating magnets in order to keep the rotating magnets at a minimum predetermined distance from their respective swinging targets, wherein said means for the rotating magnets to shuttle also include twins of trapdoor and trigger, each twin is configured to trap the respective rotating magnet for their respective swinging target, wherein said means for the rotating magnets to shuttle also include over the spindle swinging springy hammers and their corresponding under the spindle swinging springy anvils and are configured to swing by their respective pendulum weights, wherein each over the spindle swinging springy hammer is adapted to pound upon its respective under the spindle swinging springy anvil at the 90 degrees zone and at the 270 degrees zone.

4. The energy source system according to claim 3, wherein each rotating magnet is configured to shuttle inward toward its respective over the spindle swinging target or outward toward its respective under the spindle swinging target at the moment said swinging targets change the directions of their swings, wherein one of said swinging targets continues its swing riding the rotating magnet and the other of said swinging targets departs said rotating magnet and swings in the opposite direction.

5. The energy source system according to claim 4, wherein each rotating magnet is configured to drive its respective over the spindle swinging target from the 90 degrees zone to the 270 degrees zone over the spindle and to drive its respective under the spindle swinging target from the 270 degrees zone to the 90 degrees zone under the spindle in a counterclockwise rotation of the rotating magnet, or vise versa in a clockwise rotation of the rotating magnet.

6. The energy source system according to claim 4, wherein each over the spindle swinging target is configured to descend and to encounter its respective ascending rotating magnet and the ascending under the spindle swinging target and with the respective twin trapdoor and trigger to trap said rotating magnet and through the inertia of the flywheel to prompt said respective under the spindle swinging target to depart from said rotating magnet at the moment said under the spindle swinging target changes its swing direction and descends and thus prompting said rotating magnet to shuttle toward said over the spindle swinging target as said over the spindle swinging target changes its swing direction in the direction of said ascending rotating magnet.

7. The energy source system according to claim 4, wherein each under the spindle swinging target is configured to ascend and to encounter its respective descending rotating magnet and the descending over the spindle swinging target and with the respective twin trapdoor and trigger to trap said rotating magnet and through the inertia of the flywheel to prompt said over the spindle swinging target to depart from said rotating magnet at the moment said over the spindle swinging target changes its swing direction and ascends and thus prompting said rotating magnet to shuttle toward said under the spindle swinging target as said under the spindle swinging target changes its swing direction in the direction of said descending rotating magnet.

8. The energy source system according to claim 4, wherein the balance is configured to tip in the direction the rotating magnets shuttle in the one-way linear direction.

9. The energy source system according to claim 3, wherein in each twin of trapdoor and trigger the trapdoor is configured to be opened by the trigger so that the respective swinging target traps and holds the respective rotating magnet until the departure of its respective swinging target and until said rotating magnet is shuttled inward towards its axis of rotation or outward away from its axis of rotation.

10. The energy source system according to claim 3, wherein the pounding by the over the spindle swinging springy hammers upon their respective under the spindle swinging springy anvils together with the inertia of the flywheel are configured to bring about swifter swings change in the directions of the swinging targets in order to maintain the swinging heights of the swinging pendulum weights and to maintain steady rotation by the rotating magnets.

11. The energy source system according to claim 1, wherein each rotating magnet is configured to convert its one-way linear energy into rotary energy stored by the flywheel for intersystem consumption and to store the extra potential energy that is created and unused by means for output consumption.

12. The energy source system according to claim 11, wherein the means for output consumption could be a high-speed flywheel configured to convert its stored rotary energy into electricity, wherein the energy source system could be placed within electrical vehicle to charge its batteries and it could be placed within a rotating chamber to create an artificial pulling force that resembles the pull of gravity for the system where gravity pull is insufficient, or non-existent.

13. A method of converting the energy of magnetic fields to linear energy and the linear energy to rotational energy, comprising the steps of turning a spindle and a flywheel in one direction and swinging two pendulum weights and their respective swinging magnets and their respective swinging hammer and anvil by a mass-unit that rotates in one direction and shuttles in a linear one-way direction between the swinging magnets and between its inner and outer blockers.

14. The method according to claim 13, wherein the spindle is held by a frame and the flywheel is fixed to the spindle, wherein the swinging magnets swings in the opposite direction to each other, one over the spindle and the other under the spindle, wherein the swinging hammer swings over the spindle and the swinging anvil swings under the spindle in the opposite direction to each other so that the swinging hammer pounds upon the swinging anvil at the 90 degrees mark and at the 270 degrees mark, wherein the rotating mass-unit shuttles between the swinging magnets by the magnetic field of the swinging magnets at the 90 degrees mark and at the 270 degrees mark in a one-way linear direction, wherein the inner blocker blocks the rotating mass-unit from approaching the over the spindle swinging magnet too close and the outer blocker blocks the rotating mass-unit from approaching the under the spindle swinging magnet too close.

15. The method according to claim 14, wherein each swinging magnet has a set of one trapdoor and one trigger in order to trap the rotating mass-unit until the rotating mass-unit shuttles from the swinging magnet that rides the rotating mass-unit toward the swinging magnet that trapped the rotating mass-unit.

16. The method according to claim 14, wherein the over the spindle swinging magnet encounters the rotating mass-unit at the inner side of the rotating mass-unit and the under the spindle swinging magnet encounters the rotating mass-unit at the outer side of the rotating mass-unit, wherein as soon as the mass-unit is between the swinging magnets at the 90 degrees mark, the over the spindle swinging hammer pounds over the under the spindle swinging anvil at the 270 degrees and the swinging magnets change their swings direction, wherein as soon as the rotating mass-unit is between the swinging magnets at the 270 degrees mark, the over the spindle swinging hammer pounds on the under the spindle swinging anvil at the 90 degrees mark and the swinging magnets change their swings direction.

17. The method according to claim 16, wherein as the over the spindle swinging magnet rides the rotating mass-unit and travels 180 degrees over the spindle in the direction of the rotating mass-unit, the under the spindle swinging magnet travels 180 degrees under the spindle in the opposite direction, wherein as the under the spindle swinging magnet rides the rotating mass-unit and travels 180 degrees under the spindle in the direction of the rotating mass-unit, the over the spindle swinging magnet travels 180 degrees over the spindle in the opposite direction.

18. The method according to claim 17, wherein when the rotating mass-unit shuttles towards the over the spindle swinging magnet at the 90 degrees mark into a one-way linear direction until blocked by the inner blocker and when the rotating mass-unit shuttles towards the under the spindle swinging magnet at the 270 degrees mark into a one-way linear direction until blocked by the outer blocker, the rotating mass-unit is rotating counterclockwise, wherein when the rotating mass-unit shuttles towards the over the spindle swinging magnet at the 270 degrees mark into a one-way linear direction until blocked by the inner blocker and when the rotating mass-unit shuttles towards the under the spindle swinging magnet at the 90 degrees mark into a one-way linear direction until blocked by the outer blocker, the rotating mass-unit is rotating clockwise.

19. The method according to claim 16, wherein the pounding by the over the spindle swinging hammer upon the under the spindle swinging anvil is configured to equalize the forces exerted on the pendulum weights and their swinging magnets and to prompt the swinging magnets to change their swings direction effectively without a pause.

20. The method according to claim 18, wherein the shuttles of the rotating mass-unit in the one-way linear direction is configured to convert the energy of the magnetic pulls of the swinging magnets into linear energy and the linear energy into rotational energy stored in the flywheel in order for the inertia of the flywheel to prompt the swinging magnet that rides the rotating mass-unit to release the rotating mass-unit and to transfer the rotating mass-unit to the swinging magnet that traps the rotating mass-unit in order to effectively maintain the rotating mass-unit in a steady unidirectional rotation.
